(19) United States
(12) Patent Application Publication
(10) Pub. No.: US 2014/0154614 A1
(43) Pub. Date: Jun. 5, 2014

(54) METHOD FOR PREPARING COLORFUL THREE-DIMENSIONAL HOLOGRAM BASED ON HOLOGRAPHIC POLYMER DISPERSED LIQUID CRYSTAL GRATING

(71) Applicant: Huazhong University of Science and Technology, Wuhan (CN)

(72) Inventors: Xiaolin Xie, Wuhan (CN); Haiyan Peng, Wuhan (CN); Xingping Zhou, Wuhan (CN); Chengfu Zheng, Wuhan (CN); Hongwei Ge, Wuhan (CN)

(21) Appl. No.: 14/131,672

(22) PCT Filed: May 24, 2012
(86) PCT No.: PCT/CN2012/076013

§ 371 Date: Jan. 8, 2014

(30) Foreign Application Priority Data
Jul. 26, 2011 (CN) 201110210614.9

(51) Int. Cl. G03H 1/20

(52) U.S. Cl. CPC G03H 1/20
USPC 430/2

(57) ABSTRACT

A method for preparing a colorful three-dimensional hologram based on holographic polymer dispersed liquid crystal gratings comprises: first, in a 441.6 nm laser interference field, preparing with holography a holographic master (7) which stores the reflected (or transmitted) light wave information (amplitude and phase) of an object captured; then using an object light (6) to irradiate the holographic master at a Bragg angle to generate a diffraction light (8); and using the diffraction light and a reference light (10) to simultaneously irradiate a holographic base board (9) comprising a photosensitizer, a co-initiator, a monomer capable of free radical polymerization , and a liquid crystal so that, when total optical paths of the two laser beams reaching the holographic base board are equivalent to each other, optical coherence occurs between the two laser beams on the holographic base board, thereby obtaining a colorful three-dimensional hologram based on holographic polymer dispersed liquid crystal gratings from which an image of the captured object can be observed in the sunlight.

### TECHNICAL FIELD

The present invention pertains to the functional material field, and relates to a method for preparing a colorful three-dimensional hologram based on holographic polymer dispersed liquid crystal gratings.

### BACKGROUND ART

Compared with the traditional molded imaging technology, colorful three-dimensional hologram storage and reading have better visual effects and can be widely applied in the display and anti-forgery fields. Polymers have been applied in the image storage area because they are light, durable and flexible. The holographic photopolymer materials developed by DuPont has very high diffraction efficiency (U.S. Pat. No. 5,098,803-A). However, most of the polymers cannot be used in practice because of the insufficient refractive index modulation and the consequent low diffraction inefficiency and low brightness of the corresponding holograms. Polymer dispersed liquid crystals are an effective means to broaden the range of refractive index modulation for polymers. In recent years, the emerging nanophotonics technology promotes the integration of the laser holography technology with the polymer dispersed liquid crystals, leading to the preparation of laser holographic polymer dispersed liquid crystal grating materials that have attracted much attention due to their use in the fields of high-density and high-speed mass storages, display components, modulation-enable super lenses, and high-performance sensors (Chem. Mater. 1993, 5: 1533-1538; Mol. Cryst. Liq. Cryst. 2007, 478: 907-918; Chem. Soc. Rev. 2007, 36: 1868-1880; China Patent CN101793987A). Yet, no report on methods for preparing a colorful three-dimensional hologram based on holographic polymer dispersed liquid crystal gratings is available. The present invention comprises, preparing with holography a holographic master (7) storing the reflected (or transmitted) light wave information (amplitude and phase) of an object captured; using an object light (6) to irradiate the holographic master (7) at a Bragg angle to generate a diffraction light (8) which then coheres with a reference light (10) on a holographic base board (9), thereby obtaining a colorful three-dimensional hologram based on holographic polymer dispersed liquid crystal gratings from which an image of the captured object can be observed in the sunlight.

### SUMMARY OF THE INVENTION

The present invention is intended to provide a method for preparing a colorful three-dimensional hologram based on holographic polymer dispersed liquid crystal gratings.

The technical solution of the invention is described as follows:

The present invention provides a method for preparing a colorful three-dimensional hologram based on holographic polymer dispersed liquid crystal gratings, comprising:

(1) Preparing with holography a holographic master which stores the reflected (or transmitted) light wave information (amplitude and phase) of a captured object in the medium of silver halide or dichromated gelatin;

(2) Mixing photosensitizer, co-initiator, monomer capable of free radical polymerization and liquid crystal ultrasonically and homogeneously, and perfusing the mixture into a liquid crystal cell by means of capillary action to prepare a holographic base board;

(3) Splitting, by means of a polarizing beam, a laser beam with a wavelength of 441.6 nm into two beams of light, wherein one beam is an object light, which first penetrates the holographic master and then irradiates the holographic base board, and the other beam is a reference light, which irradiates the holographic base board directly without penetrating the holographic master;

(4) Using the beam of an object light to irradiate the holographic master at a Bragg angle to generate a beam of diffraction light carrying the information of the captured object; using the diffraction light and a reference light to simultaneously irradiate the holographic base board so that when total optical paths of the two laser beams reaching the holographic base board are equivalent to each other, optical coherence occurs between the two laser beams, thereby causing monomer polymerization and consequent polymerization induced phase separation to obtain a colorful three-dimensional hologram based on holographic polymer dispersed liquid crystal gratings from which an image of the captured object can be observed in the sunlight.

The holographic base board consists of a 0.01-10 wt % photosensitizer, a 0.1-10 wt % co-initiator, a 30-90 wt % monomer capable of free radical polymerization, and a 10-70 wt % liquid crystal, and has a thickness of 10 to 30 μm.

The photosensitizer is one or more of 3,3′-diethyl thiacarbocyanine iodide, coumarin 6, coumarin 343, 7-lignocaine-3-thenoylcoumarin, 3,3′-carbonyl bis(7-diethylamine coumarin), 6-hydroxyl-7-methoxyl-4-phenyl coumarin, 7-lignocaine-3-(2-benzimidazole)coumarin, and Bis(2,6-difluoro-3-(1-hydropyrro-1-yl)-phenyl)titanocene.

The co-initiator may be one or more of N,N,N-triethylamine, N-Methyl maleimide, N-ethyl maleimide, triethanolamine, N-phenyl glycine, acetyl phenyl glycine, p-chlorophenyl glycine, 3-bromine phenyl glycine, 3-nitrile phenyl glycine, N-phenyl glycine ethyl ester, 2,4,6-tri(trichloromethyl)-1,3,5-triazine, and 2-(4′-methoxy phenyl)-4,6-bi(trichloromethyl)-1,3,5-triazine.

The monomer capable of free radical polymerization is one or more of acrylic ester, acrylic amide, and N-vinyl. The acrylic ester may be methyl methacrylate, butyl acrylate, 2-acrylic acid isooctyl ester, ethyl dimethacrylate, trimethylolpropane trimethacrylate, or pentaerythritol tetraacrylate. The acrylic amide may be methyl acrylamide, N-isopropyl acrylamide, or methylene diacrylamide. The N-vinyl monomer may be N-vinyl pyrrolidone or N-vinyl carbazole.

The liquid crystal is one or more of E7, P0616A, 5CB, 7CB, 8CB, and 5CT.

By taking advantage of high diffraction efficiency, high resolution, and high brightness provided by a holographic polymer dispersed liquid crystal grating, the present invention uses a two-step approach to preparing a colorful three-dimensional hologram based on holographic polymer dispersed liquid crystal gratings from which an image of the captured object can be observed in the sunlight. The present invention comprises preparing with holography a holographic master (7) which stores the reflected (or transmitted) light wave information (amplitude and phase) of an object captured; using an object light (6) to irradiate the holographic master (7) at a Bragg angle to generate a diffraction light (8); and using the diffraction light (8) and a reference light (10) to simultaneously irradiate a holographic base board (9) so that when total optical paths of the two laser beams reaching the holographic base board are equivalent to each other, optical coherence occurs between the two laser beams, thereby causing monomer polymerization and consequent polymerization induced phase separation to obtain a colorful three-dimensional hologram based on holographic polymer dispersed liquid crystal gratings from which an image of the captured object can be observed in the sunlight.

The holographic master uses the recording medium of silver halide or dichromated gelatin homogeneously coated on a flat glass.

### DESCRIPTION OF FIGURES

FIG. 1 shows a schematic diagram of the recording device of the colorful three-dimensional hologram based on holographic polymer dispersed liquid crystal gratings.

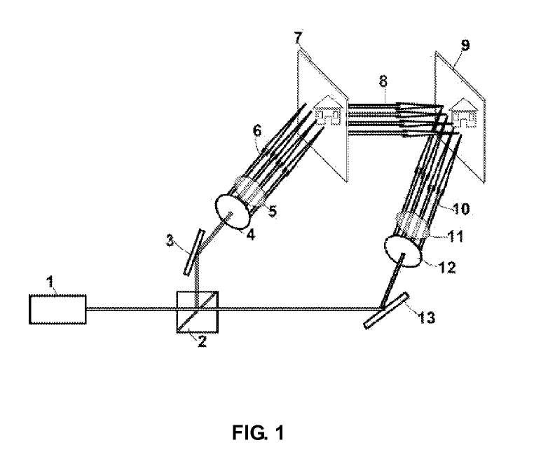

As shown in FIG. 1, the laser device (1) generates a laser beam with the wavelength of 441.6 nm, then this laser beam is split into two laser beams by the polarizing beam splitter (2), and the object light (6) and the reference light (10) are generated respectively by the planar mirrors (3 and 13) and the fourfold collimating beam expanders (4 and 12); the object light (6) irradiates the holographic master (7) carrying the information of the captured object at a Bragg angle, thereby generating the diffraction light (8) carrying the information of the captured object, and the diffraction light (8) and the reference light (10) simultaneously irradiate the holographic base board (9); when total optical paths of the two beams of laser light reaching the holographic base board (9) are equivalent to each other, optical coherence occurs between the two laser beams, thereby obtaining a colorful three-dimensional hologram based on holographic polymer dispersed liquid crystal gratings from which an image of the captured object can be observed in the sunlight.

The numeral symbols in the figure are described as follows:
1: 441.6 nm laser device
2: Polarizing beam splitter
3: Planar mirror
4: Fourfold collimating beam expander
5: Flare eliminating diaphragm
6: Object light
7: Holographic master
8: Diffraction light
9: Holographic base board
10: Reference light
11: Flare eliminating diaphragm
12: Fourfold collimating beam expander
13: Planar mirror

### PARTICULAR EMBODIMENTS

### Embodiment 1

In the 441.6 nm laser interference field, prepare with holography a holographic master storing the reflected (or transmitted) light wave information (amplitude and phase) of a captured object, use a beam of object light to irradiate the holographic master at a Bragg angle to generate a beam of diffraction light, use the diffraction light and a reference light to simultaneously irradiate a holographic base board of 10 μm thick, which consists of 0.01 wt % photosensitizers (3,3′-diethyl thiacarbocyanine iodide and coumarin 6 in the proportion of 1:1), 0.1 wt % co-initiators (N,N,N-triethylamine, N-Methyl maleimide, and 3-bromine phenyl glycine in the proportion of 1:1:2), 30 wt % monomers capable of free radical polymerization (methyl methacrylate, methyl acrylamide, and N-vinyl pyrrolidone in the proportion of 2:3:1), and 70 wt % liquid crystals (8CB and 5CT in the proportion of 2:1); when total optical paths of the two laser beams reaching the holographic base board are equivalent to each other, optical coherence occurs between the two laser beams for exposure at the exposure intensity of 0.1 mW/cm² for 500 seconds, thereby obtaining a colorful three-dimensional hologram based on holographic polymer dispersed liquid crystal gratings from which an image of the captured object can be observed in the sunlight.

### Embodiment 2

In the 441.6 nm laser interference field, prepare with holography a holographic master storing the reflected (or transmitted) light wave information (amplitude and phase) of a captured object, use a beam of object light to irradiate the holographic master at a Bragg angle to generate a beam of diffraction light, use the diffraction light and a reference light to simultaneously irradiate a holographic base board of 15 μm thick, which consists of 0.01 wt % photosensitizers (coumarin 343 and 7-lignocaine-3-thenoylcoumarin in the proportion of 1:2), 0.1 wt % co-initiators (N-ethyl maleimide, N-phenyl glycine, and 2,4,6-tri(trichloromethyl)-1,3,5-triazine in the proportion of 1:2:1), 90 wt % monomers capable of free radical polymerization (butyl acrylate, 2-acrylic acid isooctyl ester, N-isopropyl acrylamide in the proportion of 1:2:1), and 10 wt % liquid crystal E7; when total optical paths of the two laser beams reaching the holographic base board are equivalent to each other, optical coherence occurs between the two laser beams for exposure at the exposure intensity of 0.7 mW/cm² for 300 seconds, thereby obtaining a colorful three-dimensional hologram based on holographic polymer dispersed liquid crystal gratings from which an image of the captured object can be observed in the sunlight.

### Embodiment 3

In the 441.6 nm laser interference field, prepare with holography a holographic master storing the reflected (or transmitted) light wave information (amplitude and phase) of a captured object, use a beam of object light to irradiate the holographic master at a Bragg angle to generate a beam of diffraction light, use the diffraction light and a reference light to simultaneously irradiate a holographic base board of 15 μm thick, which consists of 0.01 wt % photosensitizers (3,3-carbonyl bis(7-diethylamine coumarin) and 6-hydroxyl-7-methoxyl-4-phenyl coumarin in the proportion of 1:1), 10 wt % co-initiators (triethanolamine, acetyl phenyl glycine, and 3-nitrile phenyl glycine in the proportion of 2:1:1), 70 wt % monomers capable of free radical polymerization (ethyl dimethacrylate, trimethylolpropane trimethyl acrylate, and N-vinyl carbazole in the proportion of 1:1:2), and 20 wt % liquid crystal P0616A; when total optical paths of the two laser beams reaching the holographic base board are equivalent to each other, optical coherence occurs between the two laser beams for exposure at the exposure intensity of 0.7 mW/cm² for 300 seconds, thereby obtaining a colorful three-dimensional hologram based on holographic polymer dispersed liquid crystal gratings from which an image of the captured object can be observed in the sunlight.

### Embodiment 4

In the 441.6 nm laser interference field, prepare with holography a holographic master storing the reflected (or transmitted) light wave information (amplitude and phase) of a captured object, use a beam of object light to irradiate the holographic master at a Bragg angle to generate a beam of diffraction light, use the diffraction light and a reference light to simultaneously irradiate a holographic base board of 30 μm thick, which consists of 10 wt % photosensitizers (7-lignocaine-3-(2-benzimidazole)coumarin and Bis(2,6-difluoro-3-(1-hydropyrro-1-yl)phenyl)titanocene in the proportion of 2:1), 5 wt % co-initiators (p-chlorophenyl glycine, N-phenyl glycine ethyl ester, and 2-(4′-methoxy phenyl)-4,6-bi(trichloromethyl)-1,3,5-triazine in the proportion of 1:1:1), 70 wt % monomers capable of free radical polymerization (N-vinyl carbazole, pentaerythritol tetraacrylate, and methylene diacrylamide in the proportion of 3:1:4), and 15 wt % liquid crystals (5CB and 7CB in the proportion of 1:1); when total optical paths of the two laser beams reaching the holographic base board are equivalent to each other, optical coherence occurs between the two laser beams for exposure at the exposure intensity of 20 mW/cm² for 350 seconds, thereby obtaining a colorful three-dimensional hologram based on holographic polymer dispersed liquid crystal gratings from which an image of the captured object can be observed in the sunlight.

### Embodiment 5

In the 441.6 nm laser interference field, prepare with holography a holographic master storing the reflected (or transmitted) light wave information (amplitude and phase) of a captured object, use a beam of object light to irradiate the holographic master at a Bragg angle to generate a beam of diffraction light, use the diffraction light and a reference light to simultaneously irradiate a holographic base board of 15 μm thick, which consists of a 0.01 wt % photosensitizer (3,3-carbonyl bis(7-diethylamine coumarin), a 10 wt % co-initiator (acetyl phenyl glycine), 70 wt % monomers capable of free radical polymerization (ethyl dimethacrylate, trimethylolpropane trimethacrylate, and N-vinyl carbazole in the proportion of 1:1:2), and 20 wt % liquid crystals P0616A; when total optical paths of the two laser beams reaching the holographic base board are equivalent to each other, optical coherence occurs between the two laser beams for exposure at the exposure intensity of 0.7 mW/cm² for 300 seconds, thereby obtaining a colorful three-dimensional hologram based on holographic polymer dispersed liquid crystal gratings from which an image of the captured object can be observed in the sunlight.

### Embodiment 6

In the 441.6 nm laser interference field, prepare with holography a holographic master storing the reflected (or transmitted) light wave information (amplitude and phase) of a captured object, use a beam of object light to irradiate the holographic master at a Bragg angle to generate a beam of diffraction light, use the diffraction light and a reference light to simultaneously irradiate a holographic base board of 15 μm thick, which consists of 0.01 wt % photosensitizers (3,3-carbonyl bis(7-diethylamine coumarin) and 6-hydroxyl-7-methoxyl-4-phenyl coumarin in the proportion of 1:1), 10 wt % coinitiators (triethanolamine, acetyl phenyl glycine, and 3-nitrile phenyl glycine in the proportion of 2:1:1), 70 wt % monomer capable of free radical polymerization (N-vinyl carbazole), and 20 wt % liquid crystal P0616A; when total optical paths of the two laser beams reaching the holographic base board are equivalent to each other, optical coherence occurs between the two laser beams for exposure at the exposure intensity of 0.7 mW/cm² for 300 seconds, thereby obtaining a colorful three-dimensional hologram based on holographic polymer dispersed liquid crystal gratings from which an image of the captured object can be observed in the sunlight.

1. A method for preparing a colorful three-dimensional hologram based on holographic polymer dispersed liquid crystal gratings, comprising:
(1) preparing with holography a holographic master which stores reflected (or transmitted) light wave information of a captured object in a medium of silver halide or dichromated gelatin; wherein the light wave information comprises amplitude and phase information;
(2) mixing a photosensitizer, a co-initiator, a monomer capable of free radical polymerization and a liquid crystal ultrasonically and homogeneously to form a mixture, and perfusing the mixture into a liquid crystal cell by means of capillary action to prepare a holographic base board;
(3) splitting, by means of a polarizing beam splitter, a 441.6 nm laser beam into two beams, wherein one beam is an object light, which first penetrates the holographic master and then irradiates the holographic base board, and the other another beam is a reference light, which irradiates the holographic base board directly without penetrating the holographic master;
(4) using the object light to irradiate the holographic master at a Bragg angle to generate a beam of diffraction light carrying information of the captured object;
using the diffraction light and the reference light to simultaneously irradiate the holographic base board; wherein when total optical paths of the two beams reaching the holographic base board are equivalent to each other, optical coherence occurs between the two beams, thereby causing monomer polymerization and consequent polymerization induced phase separation to obtain a colorful three-dimensional hologram based on holographic polymer dispersed liquid crystal gratings from which an image of the captured object can be observed in sunlight.

2. The method for preparing a colorful three-dimensional hologram based on holographic polymer dispersed liquid crystal gratings according to claim 1, wherein said holographic base board has a thickness of 10 to 30 μm.

3. The method for preparing a colorful three-dimensional hologram based on holographic polymer dispersed liquid crystal gratings according to claim 1, wherein said holographic base board consists of a 0.01-10 wt % photosensitizer, a 0.1-10 wt % co-initiator, a 30-90 wt % monomer capable of free radical polymerization , and a 10-70 wt % liquid crystal.

4. The method for preparing a colorful three-dimensional hologram based on holographic polymer dispersed liquid crystal gratings according to claim 1, wherein said photosensitizer is one or more of 3,3′-diethyl thiacarbocyanine iodide, coumarin 6, coumarin 343, 7-lignocaine-3-thenoylcoumarin, 3,3′-carbonyl bis(7-diethylamine coumarin), 6-hydroxyl-7-methoxyl-4-phenyl coumarin, 7-lignocaine-3 -(2-benzimidazole)coumarin, and Bis(2,6-difluoro-3 -(1-hydropyrro-1-yl)-phenyl)titanocene.

5. The method for preparing a colorful three-dimensional hologram based on holographic polymer dispersed liquid crystal gratings according to claim 1, wherein said coinitiator is one or more of N,N,N-triethylamine, N-Methyl maleimide, N-ethyl maleimide, triethanolamine, N-phenyl glycine, acetyl phenyl glycine, p-chlorophenyl glycine, 3-bromine phenyl glycine, 3-nitrile phenyl glycine, N-phenyl glycine ethyl ester, 2,4,6-tri(trichloromethyl)-1,3,5 -triazine, and 2-(4′-methoxy phenyl)-4,6-bi(trichloromethyl)-1,3,5-triazine.

6. The method for preparing a colorful three-dimensional hologram based on holographic polymer dispersed liquid crystal gratings according to claim 1, wherein said monomer capable of free radical polymerization is one or more of acrylic ester, acrylic amide, and N-vinyl monomer.

7. The method for preparing a colorful three-dimensional hologram based on holographic polymer dispersed liquid crystal gratings according to claim 1, wherein said liquid crystal is one or more of E7, P0616A, 5CB, 7CB, 8CB, and 5CT.

8. The method for preparing a colorful three-dimensional hologram based on holographic polymer dispersed liquid crystal gratings according to claim 6, wherein said acrylic ester is methyl methacrylate, butyl acrylate, 2-acrylic acid isooctyl ester, ethyl dimethacrylate, trimethylolpropane trimethacrylate, or pentaerythritol tetraacrylate.

9. The method for preparing a colorful three-dimensional hologram based on holographic polymer dispersed liquid crystal gratings according to claim 6, wherein said acrylic amide is methyl acrylamide, N-isopropyl acrylamide, or methylene diacrylamide.

10. The method for preparing a colorful three-dimensional hologram based on holographic polymer dispersed liquid crystal gratings according to claim 6, wherein said N-vinyl monomer is N-vinyl pyrrolidone or N-vinyl carbazole.
